(19) United States
(12) Patent Application Publication
(10) Pub. No.: US 2011/0061502 A1
(43) Pub. Date: Mar. 17, 2011

(54) LATHE FRAME ASSEMBLY

(76) Inventor: Chuan-Yi Liang, Taichung Hsien (TW)

(21) Appl. No.: 12/562,119

(22) Filed: Sep. 17, 2009

(51) Int. Cl. B23B 29/04

(52) U.S. Cl. 82/161

(57) ABSTRACT

A lathe frame assembly has a lathe frame, a front end of the lathe frame having an axial hole and two recesses, a clamper having a retaining hole at a middle section thereof; a front end of the clamper being installed with a protrusion which is received in a positioning hole of the lathe sheet; a lower end of the clamper having two noses which are received into the two recesses of the lathe frame so as to lock the lathe sheet; and a front end of the lathe frame having an engaging portion which is formed with two resting portions. The engaging portion has a shape selected from rectangular shapes, rhombus shapes and triangular shapes so as to clamp the lathe sheet tightly.

### FIELD OF THE INVENTION

The present invention relates to lathe frames, and particularly to a lathe frame assembly which can clamp the lathe sheet steadily and firmly so as to make the force is distributed uniformly without vibration so as to improve the quality of lathing.

### BACKGROUND OF THE INVENTION

Referring to FIG. 1, the prior art lathe frame 100 is illustrated. The front edge of the lathe frame is installed with an engaging portion with screw holes for screwing the positioning studs and pads. A lateral side of the engaging portion is formed with another screw hole for screwing a hook like clamper 101. The lathe sheet is clamped between a pad and the hook like clamper 101. However only a single point at the front edge of the clamper presses the lathe sheet. The clamping force to the lathe sheet is insufficient so that the cutting operation, a great vibration occurs so that the precision in lathing is reduced. Moreover, a rear side of the clamper has no support so that it can not suffer from a rear move force in cutting. As a result, the lathe sheet shifts from a normal position. Thus the deep cutting operation cannot be performed.

### SUMMARY OF THE INVENTION

Accordingly, the primary object of the present invention is to provide a

Accordingly, the object of the present invention is to provide a lathe frame assembly which can clamp the lathe sheet steadily and firmly so as to make the force is distributed uniformly without vibration so as to improve the quality of lathing.

To achieve above object, the present invention provides a lathe frame assembly having a lathe frame, a front end of the lathe frame having an axial hole and two recesses, a clamper having a retaining hole at a middle section thereof; a front end of the clamper being installed with a protrusion which is received in a positioning hole of the lathe sheet; a lower end of the clamper having two noses which are received into the two recesses of the lathe frame so as to lock the lathe sheet; a front end of the lathe frame having an engaging portion which is formed with two resting portions.

The engaging portion has a shape selected from rectangular shapes, rhombus shapes and triangular shapes so as to clamp the lathe sheet tightly.

Comparing with prior art, the lathe frame of the present invention can increase the steadiness in clamping of the lathe sheet so that force can be distributed uniformly without vibration. Thus the lathing quality is increased.

The various objects and advantages of the present invention will be more readily understood from the following detailed description when read in conjunction with the appended drawing.

### BRIEF DESCRIPTION OF THE DRAWINGS

FIG. 1 is a perspective schematic view of the prior art lathe frame.

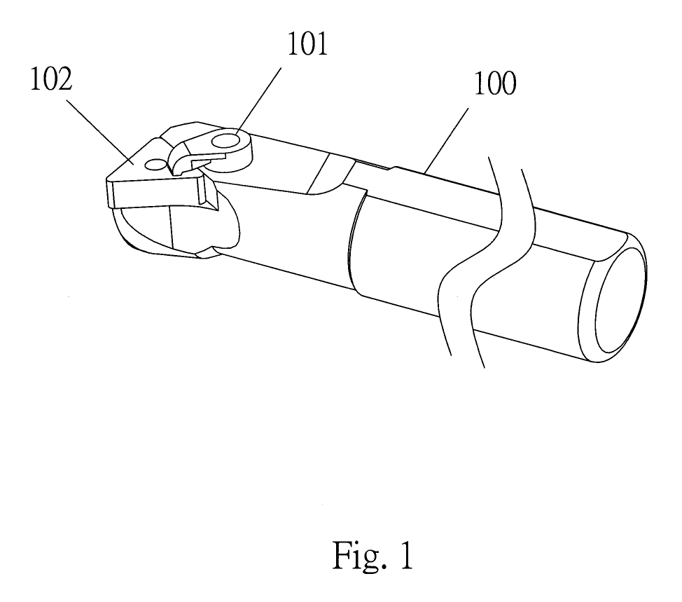

FIG. 2 is a perspective schematic view of the lathe frame of the present invention.

FIG. 3 is an exploded schematic view of the lathe frame of the present invention.

FIG. 4 is an exploded schematic view of another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

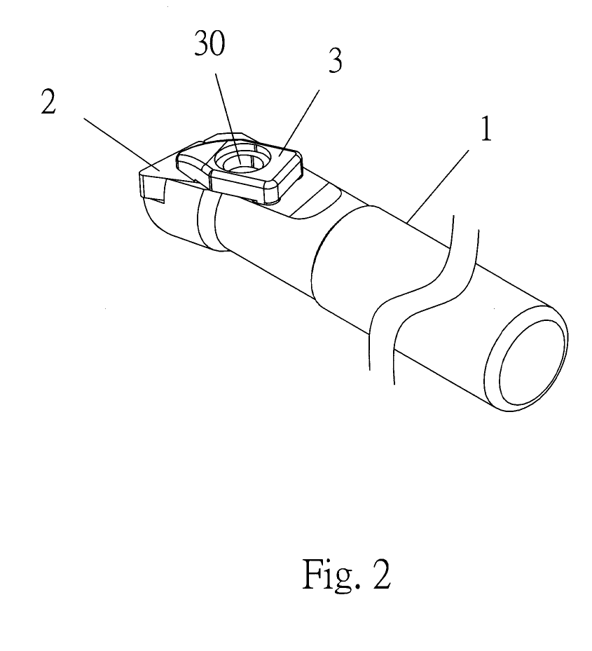

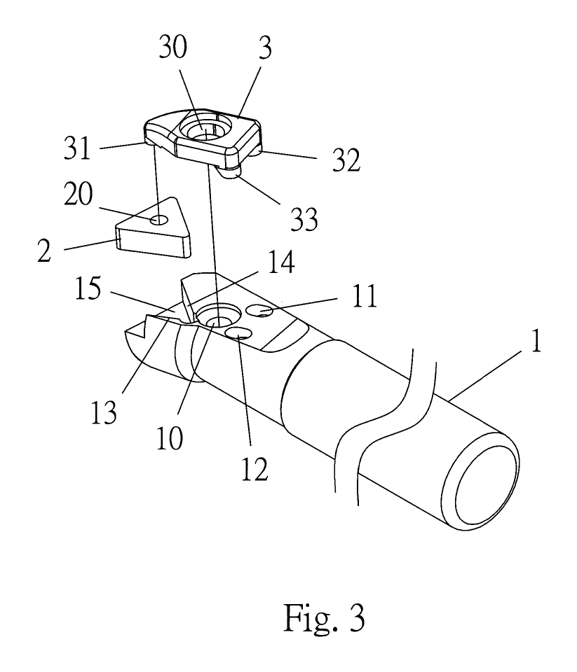

With referring to FIGS. 2 and 3, the improve lathe frame of the present invention is illustrated. The lathe frame 1 has a round shape and the lathe sheet 2 has a triangular sheet. A front end of the lathe frame 1 is formed with an axial hole 10 and two recesses 11, 12. A clamper 3 has a retaining hole 30 at a central section thereof. A front end of the clamper 3 is installed with a protrusion 31 for clamping a positioning hole of the lathe sheet 2. A lower end of the clamper 3 has two noses 32, 33 which are retained recesses 11, 12 for locking the lathe sheet 2 and dispersing reaction force in lathe operation. A front end of the lathe frame 1 is installed with an engaging portion 15. Two sides of the engaging portion 15 are formed with respective resting portions 13, 14 for clamping the lathe sheet tightly so as to reduce the vibration in lathing operation.

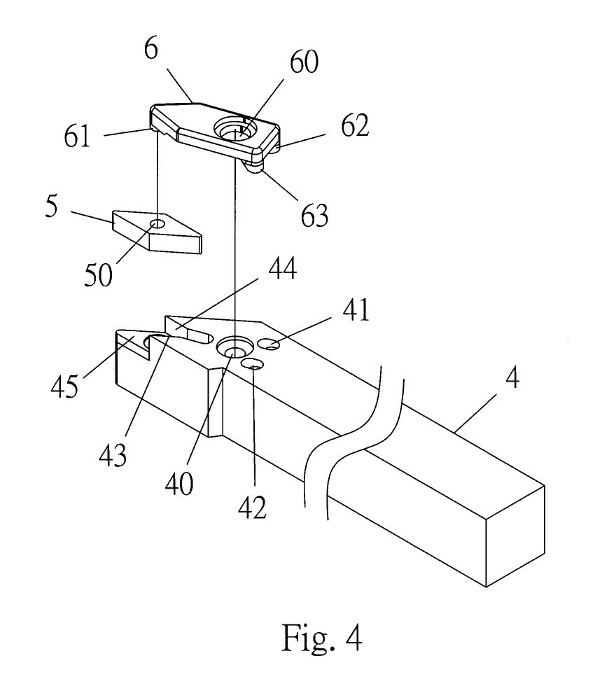

With referring to FIG. 4, the structure of the present invention is illustrated. The lathe frame 4 has a rectangular post and the lathe sheet has a rhombus shape. A front end of the lathe frame 4 is formed with an axial hole 40 and two recesses 41, 42. A clamper 6 has a retaining hole 60. A front end of the clamper is a protrusion 61 for clamping a positioning hole 50 of the lathe sheet 5. A lower end of the clamper 3 has two noses 62, 63 which are fixed to the two recesses 41, 42 of the lathe frame 4 for locking the lathe sheet 5. In lathing operation, reaction force can be dispersed. A front end of the lathe frame 4 is installed with an engaging portion which has a screw hole for combining a pad 45. Two sides of the engaging portion is formed with two resting portions 43, 44 for tightly clamping the lathe sheet 5 so as to greatly reduce the force to the lathe sheet in lathing operation and enhancing the cutting process.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A lathe frame assembly having a lathe frame, a front end of the lathe frame having an axial hole and two recesses, a clamper having a retaining hole at a middle section thereof; a front end of the clamper being installed with a protrusion which is received in a positioning hole of the lathe sheet; a lower end of the clamper having two noses which are received into the two recesses of the lathe frame so as to lock the lathe sheet; a front end of the lathe frame having an engaging portion which is formed with two resting portions.

2. The lathe frame assembly as claimed in claim 1, wherein the engaging portion has a shape selected from rectangular shapes, rhombus shapes and triangular shapes so as to clamp the lathe sheet tightly.
